(19) United States
(12) Patent Application Publication
(10) Pub. No.: US 2012/0076563 A1
(43) Pub. Date: Mar. 29, 2012

(54) IMAGE FORMING APPARATUS, MEDIA TRANSPORT SYSTEM USABLE WITH IMAGE FORMING APPARATUS, AND METHOD THEREOF

(76) Inventors: Raimon Castells De Monet, Barcelona (ES); Abel Martinez Guillén, Hospitalet de Llobregat (ES)

(21) Appl. No.: 12/893,857

(22) Filed: Sep. 29, 2010

(51) Int. Cl. B41J 11/42; B65H 7/20; B65H 7/02

(52) U.S. Cl. 400/582; 271/265.02; 271/110

(57) ABSTRACT

A media transport method includes transporting media along a media transport path by a plurality of rollers, for each of the rollers, determining a respective estimated length of advancement of the media based on at least an amount of rotation of the respective roller, and comparing the respective estimated length of advancement of the media determined for each of the rollers with each other.

### BACKGROUND

Image forming apparatuses form images on media. Image forming apparatuses such as high speed printing systems may be supplied with the media in a form of media supply rolls. In such high speed printing systems, the media is transported along a media transport path from the media supply roll to a print region. In the print region, images are formed on the media.

### BRIEF DESCRIPTION OF THE DRAWINGS

Non-limiting examples of the present disclosure are described in the following description, read with reference to the figures attached hereto and do not limit the scope of the claims. In the figures, identical and similar structures, elements or parts thereof that appear in more than one figure are generally labeled with the same or similar references in the figures in which they appear. Dimensions of components and features illustrated in the figures are chosen primarily for convenience and clarity of presentation and are not necessarily to scale. Referring to the attached figures:

FIG. 1A is a block diagram illustrating a media transport system according to an example of the present disclosure.

FIG. 1B is a side view of the media transport system of FIG. 1A according to an example of the present disclosure.

FIG. 2A is a block diagram illustrating a media transport system according to an example of the present disclosure.

FIG. 2B is a side view of the media transport system of FIG. 2A according to an example of the present disclosure.

FIG. 3 is a perspective view of a respective encoder module of a media transport system according to an example of the present disclosure.

FIG. 4 is a flowchart illustrating a media transport method according to an example of the present disclosure.

FIG. 5 is a block diagram illustrating an image forming apparatus according to an example of the present disclosure.

### DETAILED DESCRIPTION

In the following detailed description, reference is made to the accompanying drawings which form a part hereof, and in which is detected by way of illustration specific examples in which the present disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims.

Media transport systems which are usable with image forming apparatuses transport media along a media transport path. Image forming apparatuses such as roll-to-roll large-format printers, roll-to-floor large format printers, or the like, which include media transport systems have a printing unit along the media transport path to print images on the media. In such roll-to-roll large format printers, for example, the media is transported by rollers in a forward advancement direction and a reverse advancement direction along a media supply path between a media supply roll and a media receiver roll. Tension is applied on the media spanning across the media transport path to maintain the media relatively flat, for example, to reduce media transport failure, image forming apparatus failure and/or printing defects. Such failures and defects may occur, however, if adequate tension is lost, for example, due to an end of roll condition, severed media condition, roller blockage condition, or the like.

Examples of the present disclosure disclose, amongst other things, determining whether a difference exists between an estimated advanced length of the media determined with respect to two or more rollers. A user can be alerted and/or the media transport operation stopped, for example, if the determined difference is greater than a predetermined value. Furthermore, such a determination can be made in the forward advancement mode and the backward advancement mode without the use of media presence sensors and for a variety of media including photographic media. Accordingly, media transport failure, image forming apparatus failure and/or printing defects may be reduced.

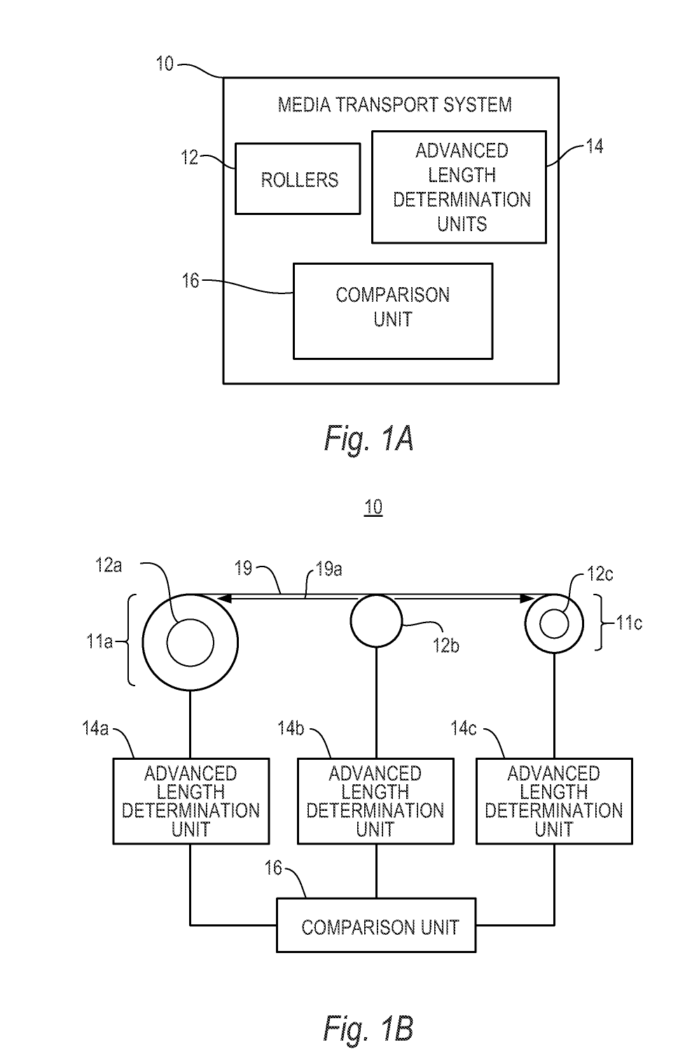

FIG. 1A is a block diagram illustrating a media transport system according to an example of the present disclosure. FIG. 1B is a side view of the media transport system of FIG. 1A according to an example of the present disclosure. Referring to FIGS. 1A and 1B, in the present example, a media transport system 10 is usable with an image forming apparatus (not illustrated). The media transport system 10 includes rollers 12, advanced length determination units 14, and a comparison unit 16. In the present example, the rollers 12 are configured to rotate to transport media 19 along a media transport path 19a.

Referring to FIGS. 1A and 1B, the advanced length determination units 14a, 14b and 14c (collectively 14) correspond to the rollers 12a, 12b and 12c (collectively 12), respectively. Each of the advanced length determination units 14 are configured to determine a respective estimated length of advancement of the media 19 based on at least an amount of rotation of the respective roller 12. The length of advancement of the media 19, for example, is a distance moved by the media 19. The estimated length of advancement of the media 19, for example, is an estimated distance moved by the media 19 determined with respect to a respective roller 12. The comparison unit 16 is configured to compare the respective estimated length of advancement of the media 19 determined by each advanced length determination units 14. Accordingly, a difference between the respective estimated lengths of advancement of the media 19 may be identified which may correspond to an end of roll condition, severed media condition, roller blockage condition, or the like.

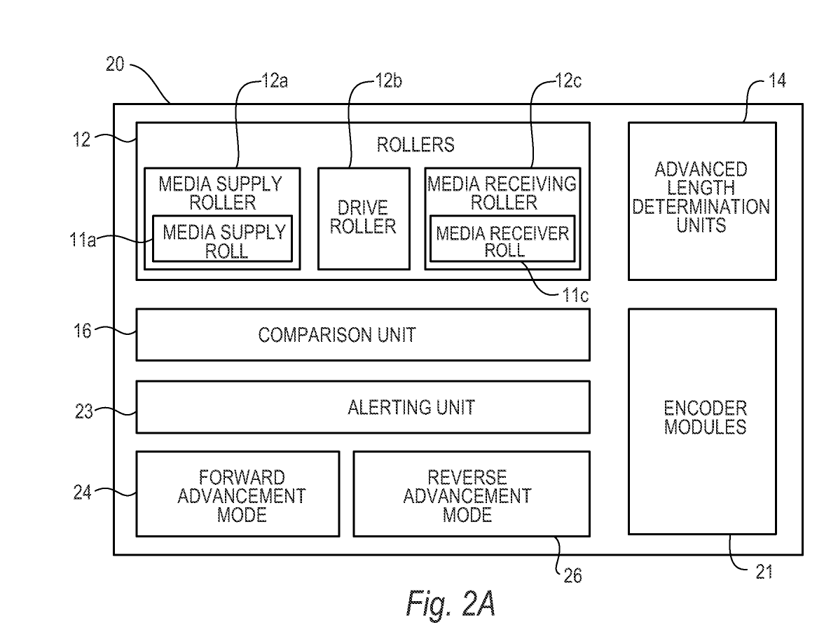

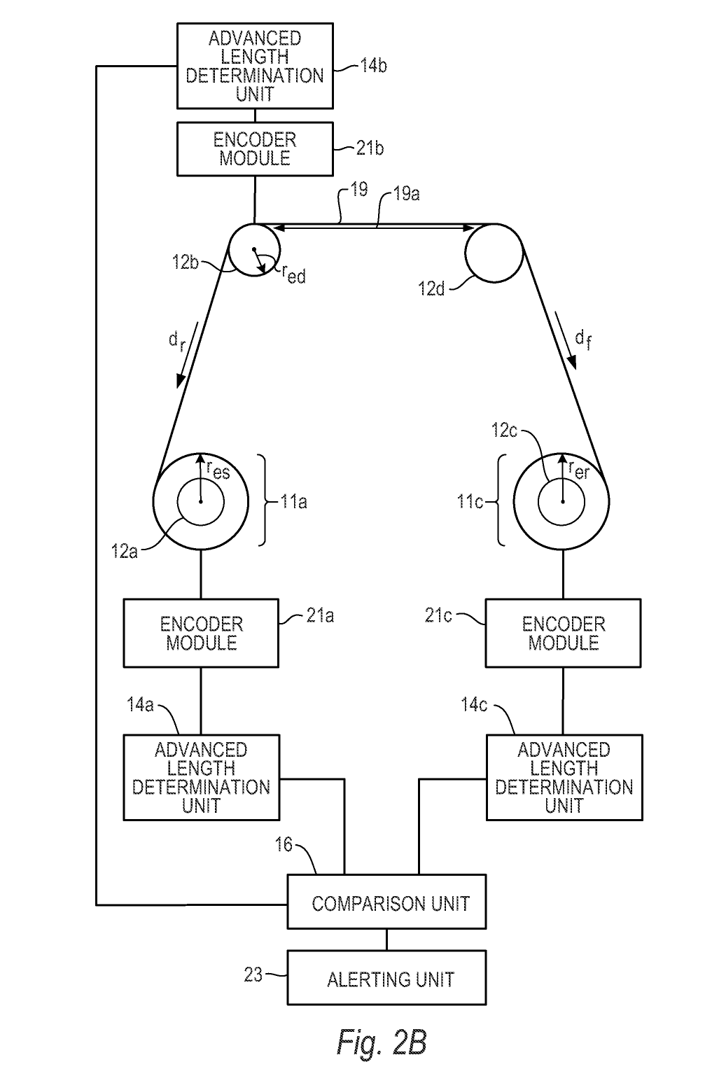

FIG. 2A is a block diagram illustrating a media transport system according to an example of the present disclosure. FIG. 2B is a side view of the media transport system of FIG. 2A according to an example of the present disclosure. Referring to FIGS. 2A and 2B, in the present example, a media transport system 20 is usable with an image forming apparatus (not illustrated). The media transport system 20 includes rollers 12, encoder modules 21, advanced length determination units 14, a comparison unit 16, an alerting unit 23, a forward advancement mode 24 and a reverse advancement mode 26. In the present example, the rollers 12 are configured to rotate to transport media 19 along a media transport path 19a. The rollers 12 may include a media supply roller 12a, a media receiving roller 12c, and a drive roller 12b. In an example, the rollers 12 may also include a diverter 12d. In the present example, the drive roller 12b is electronically controlled, for example, including a motor (not illustrated) to rotate the drive roller 12b. In examples, the media supply roller 12a and the media receiving roller 12c are electronically controlled, for example, including a motor (not illustrated) to assist with rotation of the respective rollers 12a and 12c.

Referring to FIGS. 2A and 2B, in the present example, the media supply roller 12a is configured to supply the media 19 in a form of a media supply roll 11a along the media transport path 19a. The media receiving roller 12c is configured to receive the media 19 supplied by the media supply roller 12a in a form of a media receiver roll 11c. The drive roller 12b is configured to transport the media 19 along the media transport path 19a between the media supply roller 12a and the media receiving roller 12c. In an example, the diverter 12d is configured to guide the media 19 between the media supply roller 12a and the media receiving roller 12c. The forward advancement mode 24 includes transporting the media 19 from the media supply roller 12a to the media receiving roller 12c. The reverse advancement mode 26 includes transporting the media 19 from the media receiving roller 12c to the media supply roller 12a.

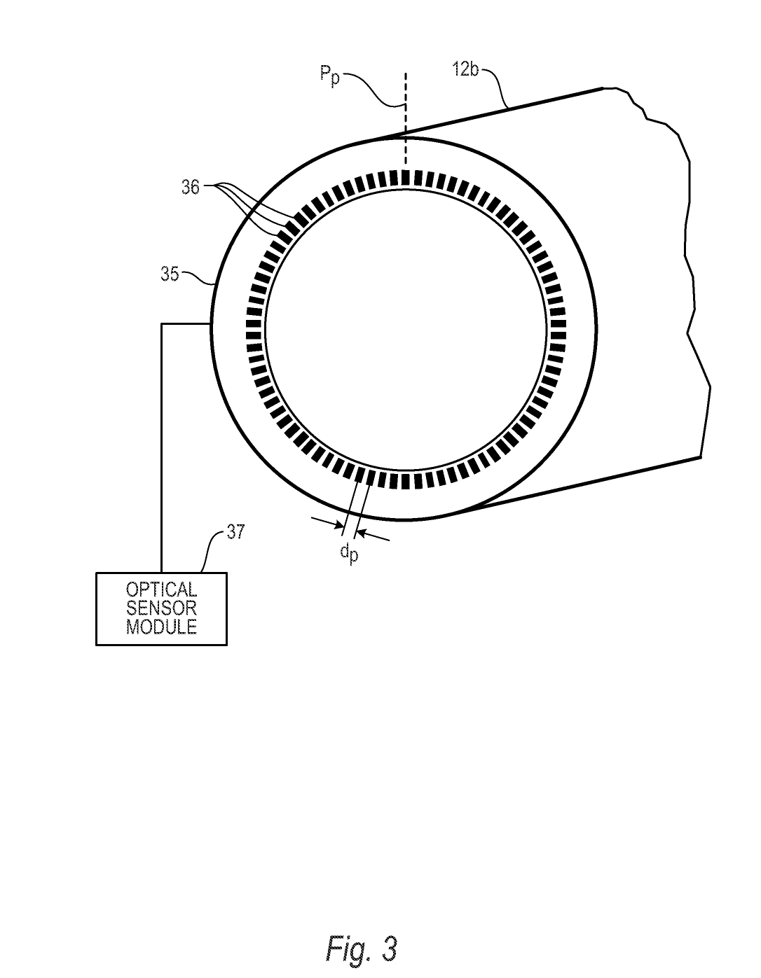

Referring to FIGS. 2A, 2B and 3, in an example, the encoder modules 21a, 21b and 21c (collectively 21) may correspond to the rollers 12a, 12b and 12c, respectively. Each encoder module 21 may include an encoder wheel 35 and an optical sensor module 37 illustrated in FIG. 3. Referring to FIG. 3, the encoder wheel 35 may be coupled to the respective roller 12 and include a number of encoder units 36 spaced apart from each other by a predetermined distance dₚ. The encoder units 36, for example, may be in a form of division marks. The optical sensor module 37 may be configured to detect a number of encoder units 36 moving past a predetermined point pₚ in response to a rotation of the respective encoder wheel 35. For example, the respective optical sensor module 37 may have a line of sight and/or detection region corresponding with the predetermined point pₚ and count the number of encoder units 36 from an initial encoder unit to a final encoder unit that move past the predetermined point pₚ.

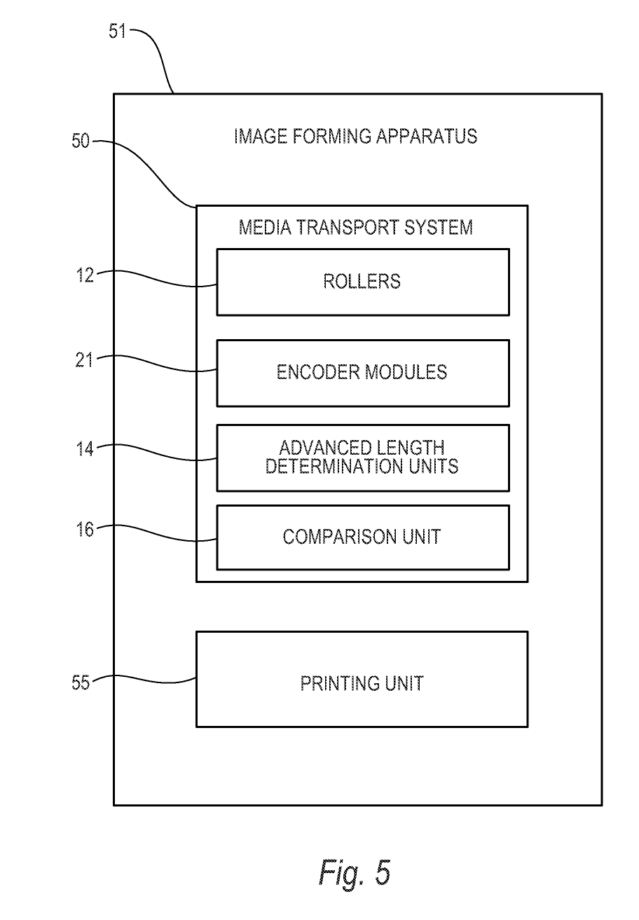

In an example, the encoder modules 21 may be implemented in hardware. In other examples, the encoder modules 21 may be implemented in a combination of hardware and software. Accordingly, the encoder modules 21 may be implemented, in part, as a computer program stored in the media transport system 20 and/or image forming system 51 (FIG. 5) locally such as in firmware or remotely, for example, in a server or a host computing device considered herein to be part of the image forming system 51.

Referring to FIGS. 2A and 2B, in the present example, the advanced length determination units 14a, 14b and 14c correspond to the rollers 12a, 12b and 12c, respectively. Each of the advanced length determination units 12 are configured to determine a respective estimated length of advancement of the media 19 based on at least an amount of rotation of the respective roller 12. In an example, each of the advanced length determination units 14 may be configured to determine a respective estimated length of advancement of the media 19 based on the respective number of encoder units 36 determined by the respective encoder module 21. In an example, each of the advanced length determination units 14 determines the respective estimated length of advancement of the media 19 by Equation 1.

Lₑₛₜ=(2×π×rₑₛₜ×X)/N, EQUATION 1:

wherein:
Lₑₛₜ is the estimated length of advancement of the media determined with respect to a respective roller;
rₑₛₜ is an effective radius of the respective roller;
X is a number of encoder units that moved past a predetermined point in response to a rotation of a respective encoder wheel corresponding to the respective roller; and
N is a total number of the encoder units disposed on the respective encoder wheel corresponding to a revolution of the respective roller.

In an example, the advanced length determination units 14 may determine the respective estimated length of advancement of the media 19 in other units of length such as centimeters by multiplying Lₑₛₜ identified in Equation 1 by a respective conversion factor. For example, a centimeter conversion factor can be used to convert encoder units to centimeters. The centimeter conversion factor may be calculated by dividing the total number of encoder units 36 per revolution of the respective roller 12 by the total amount of centimeters per revolution of the respective roller 12.

In examples, the advanced length determination units 14 may be implemented in hardware, software, or in a combination of hardware and software. Accordingly, the advanced length determination units 14 may be implemented, in whole or in part, as a computer program stored in the image forming apparatus 51 (FIG. 5) locally such as in firmware or remotely, for example, in a server or a host computing device considered herein to be part of the image forming apparatus 51.

Referring to FIG. 2B, in the present example, the effective radius r_{ed} of the drive roller 12b is equal to an actual radius of the drive roller 12b. For example, the effective radius r_{ed} of the drive roller 12b is 5.4 cm when the actual radius of the drive roller 12b is 5.4 cm. In the present example, the actual radius of the drive roller 12b remains constant. In an example, a length of the actual radius of the drive roller 12b may be stored in memory accessible by the respective advanced length determination unit 14. The effective radius rₑₛ of the media supply roller 12a is equal to an estimated radius rₑₛₜₛ of the media supply roll 11a in real-time. For example, the effective radius rₑₛ of the media supply roller 12a is 10 cm when the estimated radius rₑₛₜₛ of the media supply roll 11a remaining on the media supply roller 12a is 10 cm. In the present example, the estimated radius rₑₛₜₛ of the media supply roll 11a may change over time due to a change in the amount of media 19 remaining on the media supply roller 12a. In the present embodiment, the estimated radius rₑₛₜₛ of the media supply roll 11a is determined according to Equation 2.

rₑₛₜₛ=(I_{d}/Nₛ)(Nₜₛ/2×π), EQUATION 2:

wherein:
I_{d} is advancement length of media determined with respect to drive roller;
Nₛ is total number of encoder units that moved past a predetermined point corresponding to rotation of media supply roller; and
Nₜₛ is number of encoder units per revolution of the media supply roller.

Referring to FIG. 2B, in the present example, the effective radius rₑᵣ of the media receiving roller 12c is equal to an estimated radius rₑₛₜᵣ of the media receiver roll 11c in real-time. For example, the effective radius rₑᵣ of the media receiving roller 12c is 10 cm when the estimated radius rₑₛₜᵣ of the media receiver roll 11c remaining on the media receiving roller 12c is 10 cm. In the present example, the estimated radius rₑₛₜᵣ of the media receiver roll 11c may change over time due to a change in an amount of media 19 remaining on the media receiving roller 12c. In the present example, the estimated radius rₑₛₜᵣ of the media receiver roll 11c is determined according to Equation 3.

rₑₛₜ=(I_{d}/Nᵣ)(Nₜᵣ/2×π), EQUATION 3:

wherein:
I_{d} is advancement length of media determined with respect to drive roller;
Nᵣ is total number of encoder units that moved past a predetermined point corresponding to rotation of media receiver roller; and
Nₜᵣ is number of encoder units per revolution of the media receiver roller.

Referring to FIGS. 2A and 2B, in the present example, the comparison unit 16 is configured to compare the respective estimated length of advancement of the media 19 determined by each advanced length determination unit 14a, 14b and 14c. The comparison unit 16 may perform the respective comparisons at a predetermined interval iₚ corresponding to a predetermined amount of rotation of the drive roller 12b. In the present example, the predetermined interval iₚ may approximately 20 cm. Referring to FIGS. 2A and 2B, the alerting unit 23 is configured to alert a user in response to identification by the comparison unit 16 of a difference between the respective estimated length of advancement of the media 19 determined by the advanced length determination units 14a, 14b and 14c. In an example, the alerting unit 23 may alert the user and/or automatically stop the media transport operation when the difference is greater than a predetermined value. In the present example, the alerting unit 23 alerts the user to an end of the media supply roll 11a when the media transport system 20 is in the forward advancement mode 24 and the comparison unit 16 identifies a difference between the respective estimated length of advancement determined by the advanced length determination units 14a, 14b and 14c, greater than the predetermined value. Also, the alerting unit 23 alerts the user to an end of the media receiving roll 11c when the media transport system 20 is in the reverse advancement mode 26 and the comparison unit 16 identifies a difference between the respective estimated length of advancement determined by the advanced length determination units 14a, 14b and 14c, greater than the predetermined value.

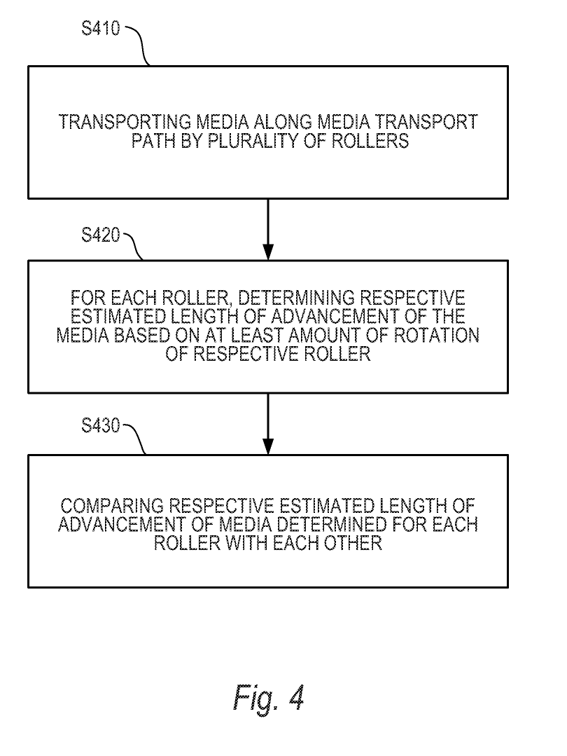

FIG. 4 is a flowchart illustrating a media transport method according to an example of the present disclosure. Referring to FIG. 4, in block S410, media is transported along a media transport path by rollers. In an example, the rollers may include a media supply roller configured to supply the media in a form of a media supply roll along the media transport path, a media receiving roller configured to receive the media supplied by the media supply roller in a form of a media receiver roll, and a drive roller configured to transport the media along the media transport path between the media supply roller and the media receiving roller. In an example, the effective radius of the media supply roller may be equal to an estimated radius of the media supply roll in real-time. The effective radius of the media receiving roller may be equal to an estimated radius of the media receiver roll in real-time. The effective radius of the drive roller may be an actual radius of the drive roller.

Referring to FIG. 4, in block S420, for each of the rollers, a respective estimated length of advancement of the media is determined based on at least an amount of rotation of the respective roller. In an example, the determination of the respective estimated length of advancement of the media may include counting a number of encoder units moving past a predetermined point in response to a rotation of a respective encoder wheel corresponding to the respective roller. The encoder units may be disposed on the respective encoder wheel and spaced apart from each other by a predetermined distance dₚ.

Referring to FIG. 4, in block S430, the respective estimated length of advancement of the media determined for each of the rollers is compared with each other. In an example, for each of the rollers, the respective estimated length of advancement of the media is determined by Equation 1 previously described. In an example, the comparing is performed at a predetermined interval corresponding to a predetermined amount of rotation of a respective roller such as a drive roller.

The transport media method may also include alerting a user and/or automatically stopping the transporting operation in response to identification of a difference between the respective estimated length of advancement determined for each of the rollers. In an example, the user is alerted by the alerting unit when the difference is greater than a predetermined value. In an example, the identification of the difference between the respective estimated length of advancement of the media determined for each of the rollers corresponds to an end of at least one of the media supply roll and the media receiver roll. In examples, the identification of the difference between the respective estimated length of advancement of the media determined for each of the rollers corresponds to at least one of a roller blockage condition, severed media condition, or the like.

FIG. 5 is a block diagram illustrating an image forming apparatus according to an example of the present disclosure. Referring to FIG. 5, in the present example, an image forming apparatus 51 includes a media transport system 50 configured to transport the media 19 (FIG. 2B) along the media transport path 19a (FIG. 2B) and a printing unit 55 configured to print an image on the media 19. In the present example, the media transport system 50 includes rollers 12, encoder modules 21, advanced length determination units 14 and a comparison unit 16.

In the present example, the rollers 12 are configured to rotate to transport media 19 along a media transport path 19a. The encoder modules 21 are coupled to the rollers 12, respectively. The encoder modules 21 are configured to determine a number of encoder units 36 (FIG. 3) moving past a predetermined point pₚ corresponding to a rotation of the respective rollers 12. The encoder modules 21 may include an encoder wheel 35 and an optical sensor module 37 as previously described and illustrated in FIG. 3. The advanced length determination units 14 correspond to rollers 12, respectively. Each of the advanced length determination units 14a, 14b and 14c (FIG. 2B) is configured to determine a respective estimated length of advancement of the media 19 based on the respective number of encoder units 36 determined by the respective encoder module 21. In the present example, for each of the rollers 12a, 1215 and 12c (FIG. 2B), the respective estimated length of advancement of the media 19 is determined by Equation 1 previously described. In an example, the comparing is performed at a predetermined interval iₚ corresponding to a predetermined amount of rotation of a respective roller 12. The comparison unit 16 is configured to compare the respective estimated length of advancement of the media 19 determined by each of the advanced length determination units 14a, 14b and 14c.

The present disclosure has been described using non-limiting detailed descriptions of examples thereof. Such examples are not intended to limit the scope of the present disclosure. It should be understood that features and/or operations described with respect to one example may be used with other examples and that not all examples of the present disclosure have all of the features and/or operations illustrated in a particular figure or described with respect to one of the examples. Variations of examples described will occur to persons of the art. Furthermore, the terms “comprise,” “include,” “have” and their conjugates, shall mean, when used in the present disclosure and/or claims, “including but not necessarily limited to.”

It is noted that some of the above described examples may describe examples contemplated by the inventors and therefore may include structure, acts or details of structures and acts that may not be essential to the present disclosure and which are described as examples. Structure and acts described herein are replaceable by equivalents, which perform the same function, even if the structure or acts are different, as known in the art. Therefore, the scope of the present disclosure is limited only by the elements and limitations as used in the claims.

What is claimed is:

1. A media transport method, comprising:
transporting media along a media transport path by a plurality of rollers;
for each of the rollers, determining a respective estimated length of advancement of the media based on at least an amount of rotation of the respective roller; and
comparing the respective estimated length of advancement of the media determined for each of the rollers with each other.

2. The method according to claim 1, further comprising:
alerting a user in response to identification of a difference between the respective estimated length of advancement determined for each of the rollers, wherein the difference is greater than a predetermined value.

3. The method according to claim 1, wherein the comparing is performed at a predetermined interval corresponding to a predetermined amount of rotation of one of the rollers.

4. The method according to claim 1, wherein the determining a respective estimated length of advancement of the media based on at least an amount of rotation of the respective roller comprises:
counting a number of encoder units moving past a predetermined point in response to a rotation of a respective encoder wheel corresponding to the respective roller, wherein the encoder units are disposed on the respective encoder wheel and spaced apart a predetermined distance from each other.

5. The method according to claim 4, wherein for each of the plurality of rollers, the respective estimated length of advancement of the media is determined by the following equation:
Lₑₛₜ=(2π×rₑₛₜ×X)/N,
wherein:
Lₑₛₜ is the estimated length of advancement of the media determined with respect to a respective roller;
rₑₛₜ is an effective radius of the respective roller;
X is a number of encoder units that moved past a predetermined point by a rotation of a respective encoder wheel corresponding to the respective roller; and
N is a total number of the encoder units disposed on the respective encoder wheel corresponding to a revolution of the respective roller.

6. The method according to claim 5, wherein the plurality of rollers comprise:
a media supply roller configured to supply the media in a form of a media supply roll along the media transport path;
a media receiving roller configured to receive the media supplied by the media supply roller in a form of a media receiver roll; and
a drive roller configured to transport the media along the media transport path between the media supply roller and the media receiving roller.

7. The method according to claim 6, wherein the identification of the difference between the respective estimated length of advancement of the media determined for each of the rollers corresponds to an end of at least one of the media supply roll and the media receiver roll.

8. The method according to claim 6, wherein:
the effective radius of the media supply roller is equal to an estimated radius of the media supply roll in real-time;
the effective radius of the media receiving roller is equal to an estimated radius of the media receiver roll in real-time; and
the effective radius of the drive roller is equal to an actual radius of the drive roller.

9. A media transport system usable with an image forming apparatus, the media transport system comprising:
a plurality of rollers configured to rotate to transport media along a media transport path;
a plurality of advanced length determination units corresponding to the plurality of rollers, respectively, each of the advanced length determination units configured to determine a respective estimated length of advancement of the media based on at least an amount of rotation of the respective roller; and
a comparison unit configured to compare the respective estimated length of advancement of the media determined by each of the plurality of advanced length determination units.

10. The system according to claim 9, further comprising:
an alerting unit configured to alert a user in response to identification by the comparison unit of a difference between the respective estimated length of advancement determined by the plurality of advanced length determination units, wherein the difference is greater than a predetermined value.

11. The system according to claim 10, wherein the plurality of rollers comprise:
a media supply roller configured to supply the media in a form of a media supply roll along the media transport path;
a media receiving roller configured to receive the media supplied by the media supply roller in a form of a media receiver roll; and
a drive roller configured to transport the media along the media transport path between the media supply roller and the media receiving roller.

12. The system according to claim 11, wherein the comparison unit performs the respective comparisons at a predetermined interval corresponding to a predetermined amount of rotation of the drive roller.

13. The system according to claim 11, further comprising:
a plurality of encoder modules corresponding to the plurality of rollers, respectively, each of the encoder modules including:
an encoder wheel coupled to the respective roller, the encoder wheel having a number of encoder units spaced apart from each other by a predetermined distance; and
an optical sensor module configured to detect a number of encoder units that moved past a predetermined point in response to a rotation of the respective encoder wheel.

14. The system according to claim 13, wherein each of the advanced length determination units determine the respective estimated length of advancement of the media by the following equation:
Lₑₛₜ=(2π×rₑₛₜ×X)/N,
wherein:
Lₑₛₜ is the estimated length of advancement of the media determined with respect to a respective roller;
rₑₛₜ is an effective radius of the respective roller;
X is a number of encoder units that moved past a predetermined point in response to a rotation of a respective encoder wheel corresponding to the respective roller; and
N is a total number of the encoder units disposed on the respective encoder wheel corresponding to a revolution of the respective roller.

15. The system according to claim 14, wherein:
the effective radius of the media supply roller is equal to an estimated radius of the media supply roll in real-time;
the effective radius of the media receiving roller is equal to an estimated radius of the media receiver roll in real-time; and
the effective radius of the drive roller is equal to an actual radius of the drive roller.

16. The system according to claim 11, further comprising:
a forward advancement mode in which the media is transported from the media supply roller to the media receiving roller; and
a reverse advancement mode in which the media is transported from the media receiving roller to the media supply roller.

17. The system according to claim 16, wherein:
the alerting unit alerts the user to an end of the media supply roll when the media transport system is in the forward advancement mode and the comparison unit identifies the difference between the respective estimated length of advancement determined by the advanced length determination units greater than the predetermined value; and
the alerting unit alerts the user to an end of the media receiving roll when the media transport system is in the reverse advancement mode and the comparison unit identifies the difference between the respective estimated length of advancement determined by the advanced length determination units greater than the predetermined value.

18. An image forming apparatus, comprising:
a media transport system configured to transport media along a media transport path, the media transport system including:
a plurality of rollers configured to rotate to transport media along a media transport path;
a plurality of encoder modules coupled to the plurality of rollers, respectively, the encoder modules configured to determine a number of encoder units moving past a predetermined point corresponding to a rotation of the respective rollers;
a plurality of advanced length determination units corresponding to the plurality of rollers, respectively, each of the advanced length determination units configured to determine a respective estimated length of advancement of the media based on the respective number of encoder units determined by the respective encoder module; and
a comparison unit configured to compare the respective estimated length of advancement of the media determined by each of the plurality of advanced length determination units; and
a printing unit configured to form an image on the media.

19. The image forming apparatus according to claim 18, wherein each of the encoder modules comprising:
an encoder wheel having a number of encoder units spaced apart from each other by a predetermined distance; and
an optical sensor module configured to detect a number of encoder units moved past a predetermined point in response to a rotation of the respective encoder wheel.

20. The image forming apparatus according to claim 19, wherein each of the advanced length determination units determine the respective estimated length of advancement of the media by the following equation:
Lₑₛₜ=(2π×rₑₛₜ×X)/N,
wherein:
Lₑₛₜ is the estimated length of advancement of the media determined with respect to a respective roller;
rₑₛₜ is an effective radius of the respective roller;
X is a number of encoder units that moved past a predetermined point in response to a rotation of a respective encoder wheel corresponding to the respective roller; and
N is a total number of the encoder units disposed on the respective encoder wheel corresponding to a revolution of the respective roller.
